(19) United States
(12) Patent Application Publication
(10) Pub. No.: US 2008/0216566 A1
(43) Pub. Date: Sep. 11, 2008

(54) APPARATUS AND METHOD FOR REMOVABLY SECURING TIRE PRESSURE MONITORING SENSOR TO A TIRE

(76) Inventor: Paul Edward Vickery, Northants (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/125,144

(22) Filed: May 22, 2008

(30) Foreign Application Priority Data
Jun. 5, 2007 (GB) GB0710725.3

(51) Int. Cl. B60C 23/04

(52) U.S. Cl. 73/146.2

(57) ABSTRACT

A reusable tire pressure sensor assembly comprises a housing member 1 having a first surface by means of which the housing member 1 is permanently attachable to a surface within the pressurised region of a wheel/tire assembly and an aperture 7 formed in the surface remote from said first surface by means of which a pocket 5 is formed between the housing 1 and the surface is accessible.

### BACKGROUND OF THE INVENTION

1. Field of the Invention

The present invention relates to an improved apparatus and method for securing a remote tire pressure monitoring sensor to the inner surface of a tire.

2. The Prior Art

It is well known in the art to use SAW devices to remotely detect the pressure within a vehicle tire. The sensor is mounted to the inner surface of either the wheel or the tire so that it is exposed to the pressurised environment therein, and is remotely interrogated in order to determine the pressure within the pressurised environment. Applicant's own earlier British Patent Application No. 0127137.8 discloses a flexible patch having an upstanding post on the end of which the sensor is mounted so as to be decoupled from the stress-field in the patch, and patch having an adhesive on its surface remote from the post by means of which it is attachable to the inner surface of a tire.

This solution for attaching the sensor to the tire is acceptable for applications such as truck tires which are re-treaded and have a service life of many hundreds of thousands of miles. But for passenger cars and the like, for which the tires have a much shorter service life, simply disposing of the sensor with the tire when the tire is changed is less acceptable as the cost implication is much greater, and it is therefore desirable for the sensor to be removable from the old tire and re-useable on the new one.

### SUMMARY OF THE INVENTION

According to the present invention there is provided a reusable tire pressure sensor comprising a housing member having a first surface by means of which the housing member is permanently attachable to a surface within the pressurised region of a wheel/tire assembly and a pocket formed in the surface remote from said first surface, a pressure sensor being removably mountable in said pocket in order to measure the pressure within the pressurised region of the wheel/tire assembly.

A reusable sensor in accordance with the invention has the advantage that it enables the more expensive sensor portion of the assembly to be removed when the tire reaches the end of its serviceable life and transferred to a new tire, thereby reducing cost.

Preferably, the sensor is mounted on a patch generally as described above from the prior art but without any adhesive on it, the main body of the patch being inserted into the pocket in the housing with the post protruding from the pocket. This has the advantage that the post acts to locate the patch within the housing and hold it in place. More particularly, the patch is a rubber patch which may be folded in order to be inserted through an opening in the housing so as to mount it within the pocket—the opening being smaller than the unfolded patch. Forming the housing of rubber then has the additional advantage that the cohesion between the rubber of the housing and the patch further operates to prevent movement of the patch within the housing.

The housing may advantageously be formed by a patch itself which has a region which is free of adhesive that is surrounded or at least bound on two sides by regions which carry adhesive, the pocket then being formed between the said adhesive free region and the region of the wheel 1 tire assembly underlying said adhesive free region. An opening is then formed in the upper surface of said adhesive free region by means of which the sensor may be inserted into and removed from the pocket.

The housing may be of unitary construction or may be formed as separate parts joined together. For example, the adhesive free region may be separately formed from the or each adhesive carrying region and be attached to an upper surface thereof.

The housing may particularly effectively be round or oval and have an oval opening by means of which the sensor is inserted into or removed from the pocket.

### BRIEF DESCRIPTION OF THE DRAWINGS

In order that the invention may be well understood, there will now be described an embodiment thereof, given by way of example, reference being made to the accompanying drawings, in which:

FIG. 1 is a plan view of a sensor assembly according to the invention; and

FIG. 2 is a section side view of the assembly of FIG. 1.

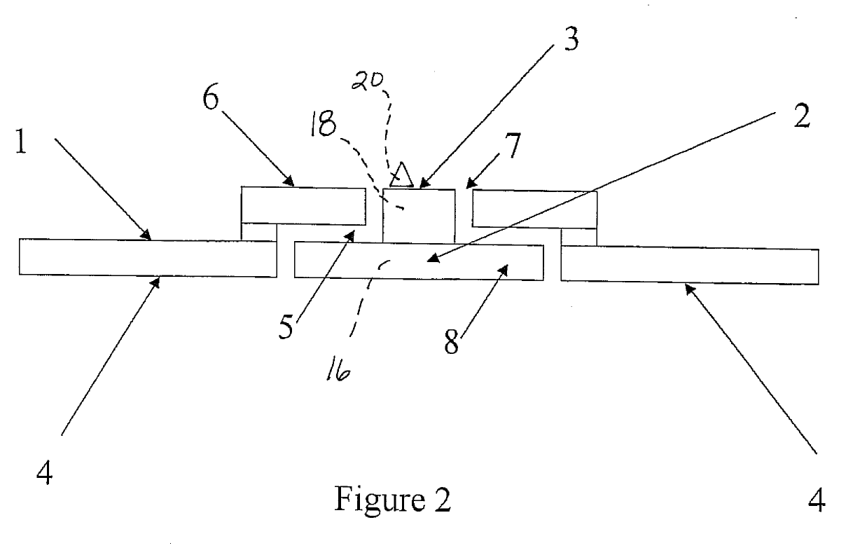

### DETAILED DESCRIPTION OF THE PREFERRED EMBODIMENT

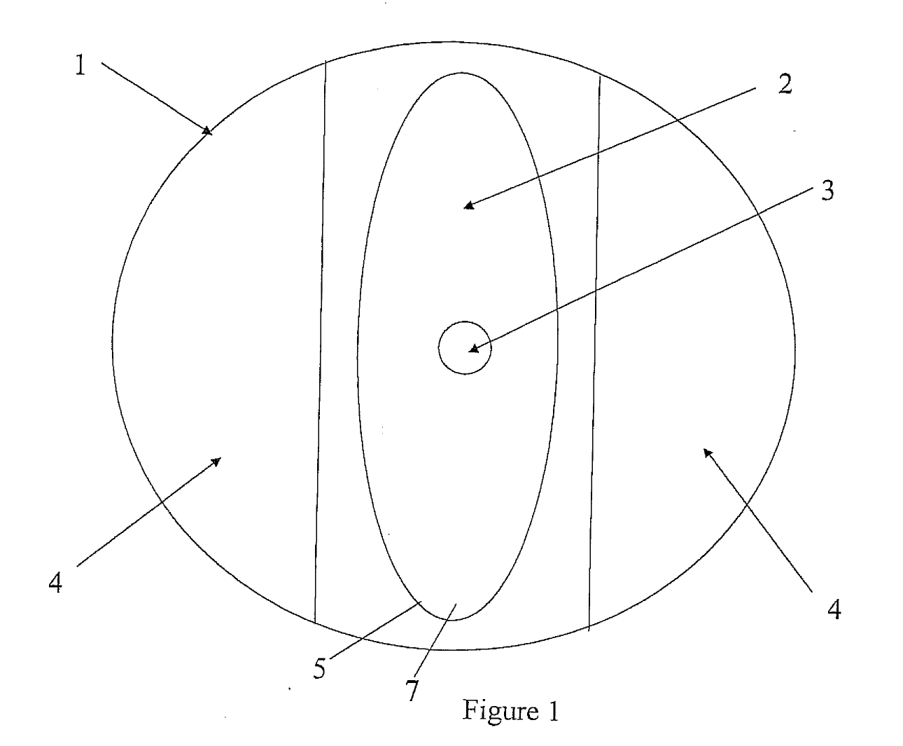

Referring first to FIG. 1, there is shown a housing 1 in the form of a mounting patch 1 having a pocket 5 formed therein for receiving a tire pressure sensor 3. The patch 1 has spaced apart fastening regions 4 by means of which it is fastened to a surface within the pressure chamber of a wheel/tire assembly, such as the inner surface of the tire. In the illustrated embodiment, this is achieved by means of adhesive carried on said regions 4. The area 6 between said fastening regions 4 is not attached to the underlying tire so that a pocket is formed which is accessible through an opening 7 formed in said area 6. The sensor 3 is carried on a sensor patch 2 having a flange portion 8 which is larger than opening 7 but foldable so as to be insertable through said opening 7 into the pocket 5, where, once unfolded, it extends beyond the periphery of the opening so as to be held in place within the pocket with the sensor 3 protruding therefrom.

The sensor patch 2 may then easily be removed by a user by simply pulling on the exposed end of the patch, application of sufficient force deforming the flange portion of the patch and allowing sensor patch carrying the sensor to be removed from the pocket 5 and mounted in the housing of another tire.

According to an alternate embodiment illustrated by dashed lead lines, there is provided a sensor patch or sensor base 16 which is removably positioned within the pocket 5 of mounting patch 1. A post 18 is mounted on base 16. Base 16 is foldable to pass through aperture 7 and then unfold within pocket 5, thereby being retained within the pocket, until forceably removed. Post 18 protrudes through aperture 7. Pressure sensor 20 is mounted on post 18.

It will of course be understood that the housing may be separately formed and permanently fastened to a wheel/tire assembly or may be integrally formed with the wheel or tire. It may also be formed in a variety of shapes.

What is claimed is:

1. A reusable tire pressure sensor comprising:
a housing member having a first surface by means of which the housing member is permanently attachable to a surface within the pressurised region of a wheel/tire assembly and an aperture formed in the surface remote from said first surface; and
a pressure sensor being removably mountable in said aperture in order to measure the pressure within the pressurised region of the wheel/tire assembly.

2. A reusable tire pressure sensor according to claim 1, wherein the portion of the first surface of the housing member surrounding the aperture, in use, is not attached to the surface of the pressurised region of the wheel/tire assembly so that a pocket is formed between the housing and the wheel/tire assembly which is accessible through the aperture into which the sensor is insertable.

3. A reusable tire pressure sensor according to claim 1, wherein the housing is formed by a mounting patch which has a region which is free of adhesive that is surrounded or at least bound on two sides by regions which carry adhesive.

4. A reusable tire pressure sensor according to claim 1, wherein the housing is of unitary construction

5. A reusable tire pressure sensor according to claim 1, wherein the housing is round or oval.

6. A reusable tire pressure sensor according to claim 1, wherein the aperture is oval.

7. A reusable tire pressure sensor according to claim 1, wherein the housing is formed of rubber.

8. A reusable tire pressure sensor assembly comprising a reusable tire pressure sensor according to claim 1 and a pressure sensor which is removable mountable within the housing via the aperture formed therein.

9. A reusable tire pressure sensor assembly according to claim 8, wherein the sensor is mounted a post which extends from a sensor patch, the sensor patch being mountable into the housing with the post protruding through the aperture.

10. A reusable tire pressure sensor assembly according to claim 8, wherein the sensor patch is a rubber patch which is foldable in order to be inserted through an opening in the housing so as to mount it within the pocket, wherein the opening is smaller than the unfolded patch.

11. A reusable tire pressure sensor comprising:
a mounting patch having a first surface having a region which is free of adhesive that is surrounded or at least bound on two sides by regions which carry adhesive, by means of which adhesive carrying regions the patch is permanently attachable to a surface within the pressurised region of a wheel/tire assembly, the adhesive free region forming a pocket between the patch and the surface, and an aperture formed in the surface remote from said first surface in the region of said pocket; and
a pressure sensor assembly having a base adapted for insertion through the aperture to secure the assembly to the mounting patch.

12. The reusable tire pressure sensor according to claim 11, wherein the pressure sensor assembly comprises a pressure sensor being insertable through the aperture so as to be removable mountable in said pocket in order to measure the pressure within the pressurised region of the wheel/tire assembly.

13. The reusable tire pressure sensor according to claim 11, wherein the pressure sensor assembly further comprising a post which extends from a foldable rubber base, the base being removably mountable into the pocket by folding so as to be insertable through the aperture with the post protruding through the aperture, the opening being smaller than the unfolded patch, wherein the sensor is mounted on the post.
